(19) United States
(12) Patent Application Publication
(10) Pub. No.: US 2025/0171331 A1
(43) Pub. Date: May 29, 2025

(54) METHOD OF PREPARING CATHODE ACTIVE MATERIAL PRECURSOR USING COUETTE-TAYLOR REACTORS

(71) Applicant: NAN YA PLASTICS CORPORATION, TAIPEI (TW)

(72) Inventors: TE-CHAO LIAO, TAIPEI (TW); WEI-SHENG CHENG, TAIPEI (TW); Wen-Ta Cheng, TAIPEI (TW); Nei-Mei Fang, TAIPEI (TW)

(21) Appl. No.: 18/424,839

(22) Filed: Jan. 28, 2024

(30) Foreign Application Priority Data
Nov. 24, 2023 (TW) 112145496

(51) Int. Cl. C01G 53/00; H01M 4/36; H01M 4/505; H01M 4/525

(52) U.S. Cl. CPC C01G 53/66; C01G 53/40; C01G 53/50; H01M 4/366; H01M 4/505; H01M 4/525; C01P 2002/50; C01P 2004/03; C01P 2004/61; C01P 2004/86; C01P 2006/40

(57) ABSTRACT

A method of preparing cathode active material precursors includes feeding a first reaction liquid into a first Couette-Taylor reactor and performing a co-precipitation reaction to continuously form and output a first product liquid stream containing a plurality of core particles; feeding the first product liquid stream into a second Couette-Taylor reactor that is connected in series after the first Couette-Taylor reactor; and feeding a second reaction liquid into the second Couette-Taylor reactor to react with the core particles, so as to form the cathode active material precursors. The first reaction liquid is a multi-element metal solution, the second reaction liquid is a transition metal aqueous solution, and each of the cathode active material precursors has a core-shell structure.

### CROSS-REFERENCE TO RELATED PATENT APPLICATION

This application claims the benefit of priority to Taiwan Patent Application No. 112145496, filed on Nov. 24, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method of preparing cathode active material precursors, and more particularly to a method of preparing cathode active material precursors using Couette-Taylor reactors.

### BACKGROUND OF THE DISCLOSURE

A nickel-rich ternary or quaternary cathode active material has advantages of high energy density and low cost. However, due to limitations of mechanical properties and electrical conductivity of the cathode active material, a structure of the cathode active material is easily crushed and dissolved during repeated charging and discharging processes, thereby resulting in insufficient cycle stability.

In the related art, in order to improve a life cycle of a lithium battery, a functional material is usually coated on a surface of the ternary or quaternary cathode active material to prevent erosion from hydrofluoric acid (HF), reduce side reactions between an electrode material and an electrolyte, inhibit dissolution of metal ions, and reduce damage to a material structure during repeated charging and discharging, thereby further improving a recycling performance of the material.

However, conventional methods for preparing cathode active material precursors have several drawbacks. For instance, continuous production cannot be achieved using an impregnation method, while a dry coating method often results in uneven material distribution. Additionally, methods of sputtering and atomic layer deposition require expensive equipment and also cannot achieve continuous production. These limitations present significant challenges for efficient manufacturing of cathode active materials in lithium batteries.

### SUMMARY OF THE DISCLOSURE

In response to the above-referenced technical inadequacies, the present disclosure provides a method of preparing cathode active material precursors using Couette-Taylor reactors.

In one aspect, the present disclosure provides a method of preparing cathode active material precursors using Couette-Taylor reactors. The method includes a first Couette-Taylor reaction step, a second Couette-Taylor reaction step, and a purification step. The first Couette-Taylor reaction step includes: feeding a first reaction liquid into a first Couette-Taylor reactor; and performing a co-precipitation reaction on the first reaction liquid to continuously form and output a first product liquid stream containing a plurality of core particles. The first reaction liquid is a multi-element metal solution. The second Couette-Taylor reaction step includes feeding the first product liquid stream into a second Couette-Taylor reactor that is connected in series after the first Couette-Taylor reactor; and feeding a second reaction liquid into the second Couette-Taylor reactor, so that a functional coating layer formed by the second reaction liquid is covered on an outer surface of each of the core particles, and a second product liquid stream containing the cathode active material precursors each having a core-shell structure is then formed. The second reaction liquid is a coating material aqueous solution, and the coating material aqueous solution is a transition metal aqueous solution. The purification step includes purifying the second product liquid stream to separate the cathode active material precursors from the second product stream.

In certain embodiments, the multi-element metal solution contains at least three or more of a nickel (Ni) compound, a cobalt (Co) compound, a manganese (Mn) compound, a magnesium (Mg) compound, and an aluminum (Al) compound; in which each of the core particles is at least one of a ternary alloy hydroxide core particle and a quaternary alloy hydroxide core particle.

In certain embodiments, the transition metal aqueous solution is at least one of a zirconium ion solution, a tungsten ion solution, an aluminum ion solution, a zinc ion solution, a titanium ion solution, a molybdenum ion solution, and a tin ion solution.

In certain embodiments, a flow rate of the first reaction liquid fed into the first Couette-Taylor reactor is defined as a first liquid flow rate, and a flow rate of the second reaction liquid fed into the second Couette-Taylor reactor is defined as a second liquid flow rate. The second liquid flow rate is 3% to 20% of the first liquid flow rate.

In certain embodiments, a first liquid flow rate of the first reaction liquid fed into the first Couette-Taylor reactor is between 0.5 mL/min and 3 mL/min, a second liquid flow rate of the second reaction liquid fed into the second Couette-Taylor reactor is between 0.05 mL/min and 0.30 mL/min, and the second liquid flow rate is 3% to 20% of the first liquid flow rate.

In certain embodiments, a first reaction temperature of the first Couette-Taylor reactor is between 45° C. and 70° C., and a first rotation speed of a first rotation motor in the first Couette-Taylor reactor is between 500 rpm and 900 rpm.

In certain embodiments, a second reaction temperature of the second Couette-Taylor reactor is between 45° C. and 70° C., and a second rotation speed of a second rotation motor in the second Couette-Taylor reactor is between 400 rpm and 800 rpm.

In certain embodiments, the first Couette-Taylor reaction step further includes: respectively feeding a first chelating agent and a first precipitating agent into the first Couette-Taylor reactor to mix with the first reaction liquid, so as to form a first reaction mixture. A first residence time of the first reaction mixture in the first Couette-Taylor reactor is between 300 minutes and 600 minutes.

In certain embodiments, the second Couette-Taylor reaction step further includes: respectively feeding a second chelating agent and a second precipitating agent into the second Couette-Taylor reactor to mix with the second reaction liquid and the first product liquid stream, so as to form a second reaction mixture. A second residence time of the second reaction mixture in the second Couette-Taylor reactor is between 150 minutes and 500 minutes, and the second residence time is 50% to 85% of the first residence time.

In certain embodiments, in each of the cathode active material precursors having the core-shell structure, a core size of the core particle is between 4 micrometers and 12 micrometers, and a thickness of the functional coating layer is 1% and 20% of the core size of the core particle.

Therefore, in the method of preparing the cathode active material precursors using the Couette-Taylor reactors provided by the present disclosure, by virtue of “implementing a first Couette-Taylor reaction step that includes: feeding a first reaction liquid into a first Couette-Taylor reactor; performing a co-precipitation reaction on the first reaction liquid to continuously form and output a first product liquid stream containing a plurality of core particles; in which the first reaction liquid is a multi-element metal solution,” and “implementing a second Couette-Taylor reaction step that includes: feeding the first product liquid stream into a second Couette-Taylor reactor that is connected in series after the first Couette-Taylor reactor; feeding a second reaction liquid into the second Couette-Taylor reactor to react with the core particles, so that a functional coating layer formed by the second reaction liquid is covered on an outer surface of each of the core particles, and a second product liquid stream containing the cathode active material precursors each having a core-shell structure is then formed; in which the second reaction liquid is a coating material aqueous solution, and the coating material aqueous solution is a transition metal aqueous solution,” and “implementing a purification step that includes: purifying the second product liquid stream to separate the cathode active material precursors from the second product stream,” conventional continuous stirred reactors can be replaced, and the purpose of continuous production can be achieved.

The first Couette-Taylor reactor is used to form core particles (i.e., core portions) with uniform elements distribution and a dense structure through a co-precipitation method. Further, the second Couette-Taylor reactor is used to surface coat and modify the core particles to form cathode active material precursors each having a core-shell structure. The method of the present disclosure can achieve continuous production of cathode material precursors each having the core-shell structure, which effectively enhances stability and endurance of lithium batteries, while also ensuring safety of the materials.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a system using Couette-Taylor reactors for preparing a cathode active material precursor according to an embodiment of the present disclosure;

FIG. 2A is an SEM photograph of a cathode active material having a core-shell structure of Exemplary Example 3 of the present disclosure;

FIG. 2B is an SEM photograph of a cathode active material having only a core particle of Comparative Example 1;

FIG. 3A is an SEM photograph of the cathode active material having the core-shell structure of Exemplary Example 3 of the present disclosure after 500 charge and discharge cycle tests;

FIG. 3B is an SEM photograph of the cathode active material having only the core particle of Comparative Example 1 after 500 charge and discharge cycle tests;

FIG. 4A is an SEM photograph showing a cross-sectional view of the cathode active material of FIG. 3A; and

FIG. 4B is an SEM photograph showing a cross-sectional view of the cathode active material of FIG. 3B.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

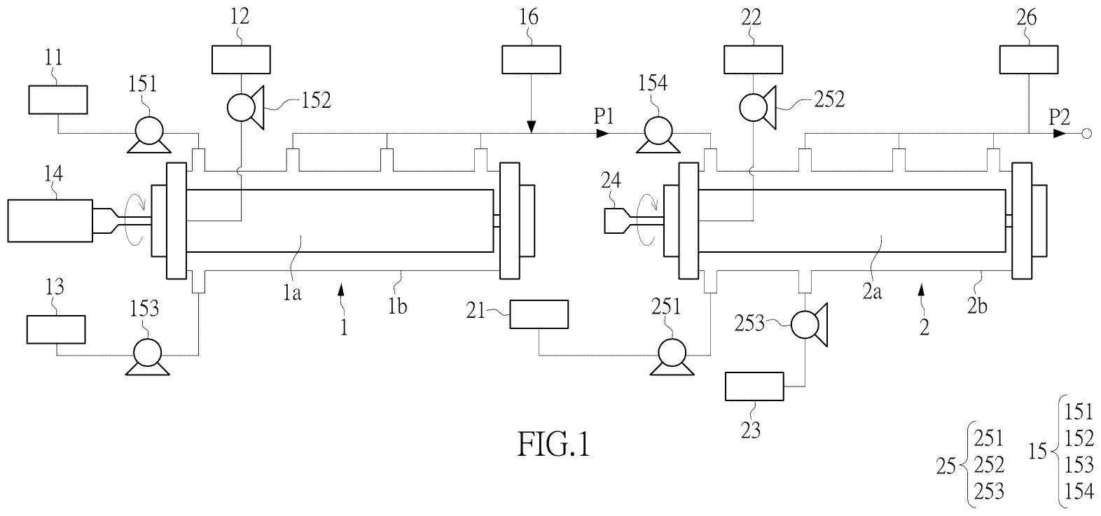

Referring to FIG. 1, an embodiment of the present disclosure provides a method of preparing cathode active material precursors using Couette-Taylor reactors to prepare the cathode active material precursors each having a core-shell structure.

In the present embodiment, the cathode active material precursors are active materials used for mixing with lithium salt (e.g., LiOH·H₂O) in a lithium battery, but the present disclosure is not limited thereto.

More specifically, the method of preparing the cathode active material precursors using the Couette-Taylor reactors includes Step S110, Step S120, and Step S130.

Step S110 is to implement a first Couette-Taylor reaction step that includes: feeding a first reaction liquid into a first Couette-Taylor reactor 1 through a first reaction liquid supply unit 11, and performing a co-precipitation reaction on the first reaction liquid to continuously form and output a first product liquid stream P1 containing a plurality of core particles. The core particles have characteristics of uniform element distribution and dense structure.

Each of the core particles is at least one of a ternary alloy hydroxide core particle and a quaternary alloy hydroxide core particle.

The first reaction liquid is a multi-element metal solution.

In some embodiments of the present disclosure, the multi-element metal solution contains at least three or more of a nickel (Ni) compound, a cobalt (Co) compound, a manganese (Mn) compound, a magnesium (Mg) compound, and an aluminum (Al) compound.

Preferably, the multi-element metal solution contains at least a nickel (Ni) compound, a cobalt (Co) compound, and a manganese (Mn) compound, and may not contain or selectively contain at least one of a magnesium (Mg) compound and an aluminum (Al) compound.

In some embodiments of the present disclosure, the nickel (Ni) compound can be, for example, nickel sulfate (NiSO₄), the cobalt (Co) compound can be, for example, cobalt sulfate (CoSO₄), the manganese (Mn) compound can be, for example, manganese sulfate (MnSO₄), the magnesium (Mg) compound can be, for example, magnesium sulfate (MgSO₄), and the aluminum (Al) compound can be, for example, aluminum sulfate (Al₂(SO₄)₃), but the present disclosure is not limited thereto.

More specifically, the first Couette-Taylor reactor 1 includes a first rotation axis 1a and a first reaction chamber 1b that surrounds the first rotation axis 1a along a radial direction.

The first reaction liquid supply unit 11, a first chelating agent supply unit 12, and a first precipitating agent supply unit 13 are respectively connected to an initial position of the first Couette-Taylor reactor 1.

The first Couette-Taylor reactor 1 further includes a first rotation motor 14 connected to the first rotation axis 1a along the axial direction, and the first rotation motor 14 is configured to drive the first rotation axis 1a to rotate along the axial direction.

The first reaction liquid supply unit 11 is configured to feed the first reaction liquid (i.e., the multi-element metal solution) into the first reaction chamber 1b of the first Couette-Taylor reactor 1 through a first liquid delivery unit 151 of a first pump module 15.

The first chelating agent supply unit 12 is configured to feed a first chelating agent (i.e., an ammonia aqueous solution, NH₄OH(aq)) into the first reaction chamber 1b of the first Couette-Taylor reactor 1 through another first liquid delivery unit 152 of the first pump module 15 to mix with the first reaction liquid (i.e., the multi-element metal solution).

The first precipitating agent supply unit 13 is configured to feed a first precipitating agent (i.e., a hydroxide aqueous solution, NaOH(aq.)) into the first reaction chamber 1b of the first Couette-Taylor reactor 1 through still another first liquid delivery unit 153 of the first pump module 15, to mix with the first reaction liquid (i.e., the multi-element metal solution) and the first chelating agent (i.e., the ammonia aqueous solution), so as to form a first reaction mixture, and then the co-precipitation reaction is performed to form the first product liquid stream P1 containing the plurality of core particles.

The first rotation motor 14 is configured to drive the first rotation axis 1a to rotate along the axial direction, so that the first reaction mixture formed of the first reaction liquid (i.e., the multi-element metal solution), the first chelating agent (i.e., the ammonia aqueous solution) and the first precipitating agent (i.e., the hydroxide aqueous solution) that are fed into the first reaction chamber 1b of the first Couette-Taylor reactor 1 can be reacted completely.

The first product liquid stream P1 containing the plurality of core particles formed in the first Couette-Taylor reaction step can be continuously output through at least one outlet of the first Couette-Taylor reactor 1.

In the first Couette-Taylor reaction step, a first pH value monitoring unit 16 is connected to a rear side of the outlet of the first Couette-Taylor reactor 1 to monitor a first pH value of the first product liquid stream P1.

In some embodiments of the present disclosure, in order to enhance reaction efficiency of the first Couette-Taylor reaction step, a first reaction temperature of the first Couette-Taylor reactor 1 is between 45° C. and 70° C., and preferably between 50° C. and 65° C.

A first rotation speed at which the first rotation motor 14 drives the first rotation axis 1a to rotate is between 500 rpm and 900 rpm, and preferably between 500 rpm and 700 rpm.

In addition, a first residence time of the first reaction mixture formed of the first reaction liquid, the first chelating agent and the first precipitating agent in the first Couette-Taylor reactor 1 is between 300 minutes and 600 minutes, and preferably between 450 minutes and 550 minutes.

A first liquid flow rate of the first reaction liquid (i.e., the multi-element metal solution) fed into the first reaction chamber 1b of the first Couette-Taylor reactor 1 through the first reaction liquid supply unit 11 is between 0.5 mL/min and 3 mL/min, and preferably between 1.0 mL/min and 2.5 mL/min.

A first chelating agent flow rate of the first chelating agent (i.e., the ammonia aqueous solution) that is fed into the first reaction chamber 1b of the first Couette-Taylor reactor 1 through the first chelating agent supply unit 12 is between 0.2 mL/min to 0.8 mL/min, and preferably between 0.4 mL/min and 0.7 mL/min.

A first precipitating agent flow rate of the first precipitating agent (i.e., the hydroxide aqueous solution) that is fed into the first reaction chamber 1b of the first Couette-Taylor reactor 1 through the first precipitating agent supply unit 13 is regulated, so that the first pH value of the first product liquid stream P1 is adjusted to be between 10 and 12.

A concentration of the hydroxide (NaOH) in the hydroxide aqueous solution ranges from 3M to 5M, but the present disclosure is not limited thereto.

In the first product liquid stream P1, a core size (i.e., particle size) of each of the core particles (i.e., a ternary or quaternary alloy hydroxide) is between 4 micrometers and 12 micrometers, and is preferably between 6 micrometers and 10 micrometers. In some embodiments of the present disclosure, each of the core particles can be a hydroxide of nickel-cobalt-manganese ternary alloy, a hydroxide of nickel-cobalt-manganese-magnesium quaternary alloy, or a hydroxide of nickel-cobalt-manganese-aluminum quaternary alloy, but the present disclosure is not limited thereto.

Step S120 is to implement a second Couette-Taylor reaction step that includes: feeding the first product liquid stream P1, which contains the plurality of core particles and is continuously outputted from the first Couette-Taylor reactor 1, into a second Couette-Taylor reactor 2 that is connected in series after the first Couette-Taylor reactor 1; and feeding a second reaction liquid into the second Couette-Taylor reactor 2 through a second reaction liquid supply unit 21, so that the second reaction liquid undergoes a surface coating modification reaction to be surface-coated on outer surfaces of the plurality of core particles. Accordingly, functional coating layers are respectively formed on the outer surfaces of the plurality of core particles, thereby forming a second product liquid stream P2 containing a plurality of cathode active material precursors each having a core-shell structure (i.e., a core-shell structure in which the outer surface of the core particle is covered with a functional coating layer).

The second reaction liquid is a coating material aqueous solution. In the present embodiment, the second reaction liquid is a transition metal aqueous solution.

For example, the transition metal aqueous solution is at least one of a zirconium ion solution, a tungsten ion solution, an aluminum ion solution, a zinc ion solution, a titanium ion solution, a molybdenum ion solution, and a tin ion solution. Preferably, the transition metal aqueous solution is the zirconium ion solution, the tungsten ion solution, or the aluminum ion solution, but the present disclosure is not limited thereto.

In some embodiments, the zirconium ion solution is a zirconium sulfate solution. The tungsten ion solution is a solution prepared by dissolving sodium tungstate dihydrate and sodium hypophosphite in deionized water. The aluminum ion solution is a solution prepared by dissolving aluminum nitrate in deionized water. However, the present disclosure is not limited thereto.

More specifically, the second Couette-Taylor reactor 2 includes a second rotation axis 2a and a second reaction chamber 2b that surrounds the second rotation axis 2a along a radial direction. 2b. In the present embodiment, the second Couette-Taylor reactor 2 is disposed on the rear side of the first Couette-Taylor reactor 1 along an axial direction. The second Couette-Taylor reactor 2 is configured to receive the first product liquid stream P1 continuously outputted from the first Couette-Taylor reactor 1.

The second reaction liquid supply unit 21, a second chelating agent supply unit 22, and a second precipitating agent supply unit 23 are respectively connected to an initial position of the second Couette-Taylor reactor 2 that is close to the first Couette-Taylor reactor 1.

In the present embodiment, a position where the second reaction liquid supply unit 21 inputting the second reaction liquid (i.e., the coating material aqueous solution) into the second Couette-Taylor reactor 2 and a position where the first product liquid stream P1 is inputted into the second Couette-Taylor reactor 2 are symmetrical to each other in the radial direction of the second Couette-Teller reactor 2. Therefore, the first product liquid stream P1 and the second reaction liquid can be fully mixed with each other, but the present disclosure is not limited thereto.

The second Couette-Taylor reactor 2 further includes a second rotation motor 24 connected to the second rotation axis 2a along the axial direction, and the second rotation motor 24 is configured to drive the second rotation axis 2a to rotate along the axial direction.

The first product liquid stream P1 is fed into the second reaction chamber 2b of the second Couette-Taylor reactor 2 through yet another first liquid delivery unit 154 of the first pump module 15.

The second reaction liquid supply unit 21 is configured to feed the second reaction liquid (i.e., the coating material aqueous solution) into the second reaction chamber 2b of the second Couette-Taylor reactor 2 through a second liquid delivery unit 251 of a second pump module 25.

The second chelating agent supply unit 22 is configured to feed a second chelating agent (i.e., an ammonia aqueous solution, NH₄OH(aq)) into the second reaction chamber 2b of the second Couette-Taylor reactor 2 through another second liquid delivery unit 252 of the second pump module 25 to mix with the second reaction liquid (i.e., the coating material aqueous solution) and the first product liquid stream P1 containing the plurality of core particles.

The second precipitating agent supply unit 23 is configured to feed a second precipitating agent (i.e., a hydroxide aqueous solution, NaOH(aq.)) into the second reaction chamber 2b of the second Couette-Taylor reactor 2 through still another second liquid delivery unit 253 of the second pump module 25, to mix with the second reaction liquid (i.e., the coating material aqueous solution), the second chelating agent (i.e., the ammonia aqueous solution), and the first product liquid stream P1 containing the plurality of core particles, so as to carry out a surface coating modification reaction.

Accordingly, the second Couette-Taylor reactor 2 can continuously form and output a second product liquid stream P2 containing a plurality of cathode active material precursors each having a core-shell structure (i.e., the outer surface each core particle is covered with a functional coating layer).

In the second Couette-Taylor reaction step, a second pH value monitoring unit 26 is connected to a rear side of the outlet of the second Couette-Taylor reactor 2 to monitor a second pH value of the second product liquid stream P2.

In some embodiments of the present disclosure, in order to enhance reaction efficiency of the second Couette-Taylor reaction step, a second reaction temperature of the second Couette-Taylor reactor 2 is between 45° C. and 70° C., and preferably between 50° C. and 65° C.

A second rotation speed at which the second rotation motor 24 drives the second rotation axis 2a to rotate is between 400 rpm and 800 rpm, and preferably between 400 rpm and 700 rpm. More preferably, the second rotation speed is lower than the first rotation speed of the first rotation motor 14, but the present disclosure is not limited thereto.

In addition, a second residence time of a second reaction mixture formed of the first product liquid stream P2, the second reaction liquid, the second chelating agent and the second precipitating agent in the second Couette-Taylor reactor 2 is between 150 minutes and 500 minutes, and preferably between 240 minutes and 400 minutes. Preferably, the second residence time of the second reaction mixture in the second Couette-Taylor reactor 2 is 50% % to 85% of the first residence time of the first reaction mixture in the first Couette-Taylor reactor, but the present disclosure is not limited thereto.

A second liquid flow rate of the second reaction liquid (i.e., the coating material aqueous solution) fed into the second reaction chamber 2b of the second Couette-Taylor reactor 2 through the second reaction liquid supply unit 21 is between 0.05 mL/min and 0.3 mL/min, and preferably between 0.1 mL/min and 0.25 mL/min. Furthermore, the second liquid flow rate is 3% to 20% (preferably 8% to 15%) of the first liquid flow rate of the first reaction liquid (i.e., the multi-element metal solution) fed into the first Couette-Taylor reactor 1.

A second chelating agent flow rate of the second chelating agent (i.e., the ammonia aqueous solution) that is fed into the second reaction chamber 2b of the second Couette-Taylor reactor 2 through the second chelating agent supply unit 22 is between 0.1 mL/min to 0.6 mL/min, and preferably between 0.1 mL/min and 0.5 mL/min.

A second precipitating agent flow rate of the second precipitating agent (i.e., the hydroxide aqueous solution) that is fed into the second reaction chamber 2b of the second Couette-Taylor reactor 2 through the second precipitating agent supply unit 23 is regulated, so that the second pH value of the second product liquid stream P2 is adjusted to be between 10 and 12. Further, a concentration of the hydroxide (NaOH) in the hydroxide aqueous solution ranges from 3M to 5M, but the present disclosure is not limited thereto.

In the second product liquid stream P2, each of the cathode active material precursors has a core particle (i.e., a core portion) and a functional coating layer (i.e., a shell layer) covering the outer surface of the core particle. The core particle has a core size (i.e. particle size) of between 4 micrometers and 12 micrometers, and preferably between 6 micrometers and 10 micrometers. Furthermore, a thickness of the functional coating layer is 1% to 20% (preferably 1% to 15%) of the core size of the core particle, but the present disclosure is not limited thereto.

In some embodiments of the present disclosure, each of the core particles can be a hydroxide of nickel-cobalt-manganese ternary alloy, a hydroxide of nickel-cobalt-manganese-magnesium quaternary alloy, or a hydroxide of nickel-cobalt-manganese-aluminum quaternary alloy.

Furthermore, the functional coating layer is a coating layer containing transition metal elements (e.g., zirconium, tungsten, and/or aluminum) to protect the core particle.

It is worth mentioning that the above-mentioned process conditions are designed for a Couette-Taylor reactor having a volume of one liter (L), but the present disclosure is not limited thereto. The volume of the Couette-Taylor reactor can be enlarged to 10 liters to 1000 liters for reaction, and the process conditions can be adjusted accordingly.

Further, Step S130 is to implement a purification step that includes purifying the second product liquid stream P2 containing the cathode active material precursors each having the core-shell structure outputted from the second Couette-Taylor reactor 2, so as to separate the cathode active material precursors from the second product liquid stream P2.

More specifically, the purification step includes: filtering the second product liquid stream P2 to filter out the cathode active material precursors, and then washing and drying the cathode active material precursors to obtain purified cathode active material precursors.

In some embodiments of the present disclosure, the purified cathode active material precursors can be further mixed and ball-milled with a lithium-containing compound (i.e., a lithium source) to obtain a crude product of cathode oxide. Then, a high-temperature tubular furnace is used to introduce an oxygen gas to calcine the crude product of the cathode oxide at a high-temperature, thereby obtaining a cathode oxide, which can be used as a cathode material for lithium batteries.

In the present embodiment, the lithium-containing compound is lithium hydroxide (LiOH), and the cathode oxide is a nickel-rich cathode oxide, but the present disclosure is not limited thereto.

As described above, the embodiment of the present disclosure provides the method of preparing the cathode active material precursors using the Couette-Taylor reactors, which includes the first Couette-Taylor reactor 1 and the second Couette-Taylor reactor 2 connected in series. The method can continuous produce the cathode active material precursors.

The first Couette-Taylor reactor is used to form core particles (i.e., core portions) with uniform elements distribution and a dense structure through a co-precipitation method. Further, the second Couette-Taylor reactor is used to surface coat and modify the core particles to form cathode active material precursors each having a core-shell structure.

The method of the embodiment of the present disclosure can continuously produce cathode active material precursors each having the core-shell structure (i.e., a core-shell nickel-rich ternary/quaternary cathode composite material precursor).

The cathode active material precursors are coated and modified with functional materials under the action of high energy density, which is expected to effectively improve the stability and endurance of the battery, and to achieve high gram capacitance and capacitance maintenance rate while taking into account the safety of the material.

The method of the embodiment of the present disclosure uses the first Couette-Taylor reactor and the second Couette-Taylor reactor connected in series to replace traditional continuous stirred reactors. The cathode active material precursors are prepared using a co-precipitation method. By adjusting the reaction temperature, rotation speed, and precipitant dripping time, the particle size, crystallinity, and specific surface area of the cathode active material precursors can be controlled. Accordingly, the method of the embodiment of the present disclosure is suitable for industrial continuous production.

The method of the embodiment of the present disclosure uses the coating material aqueous solution to heat-treat and be coated on the core particles in a Taylor flow of the second Couette-Taylor reactor, so that a functional coating layer is formed on each of the core particles.

The functional coating layer has a thin and uniform thickness, and can be completely covered on the cathode active core particles, so that the cathode active core particles are protected from electrolyte attack, thereby inhibiting the occurrence of side reactions.

The method of the embodiment of the present disclosure improves the shortcomings of conventional production methods, e.g., continuous production cannot be achieved using an impregnation method, while a dry coating method often results in uneven material distribution. Additionally, methods of sputtering and atomic layer deposition require expensive equipment and also cannot achieve continuous production. After a long period of charge and discharge testing, the cathode active material precursors according to the embodiment of the present disclosure has fewer particle cracks than the cathode active core particles that are not covered with functional coating layers. When the cathode active material precursors according to the embodiment of the present disclosure are used in a lithium battery, a life cycle of the lithium battery is significantly improved.

### [Experimental Data and Test Results]

The content of the present disclosure will be described in detail below with reference to Exemplary Examples 1 to 3 and Comparative Example 1. However, the following examples are only used to help understand the present disclosure, and the scope of the present disclosure is not limited to these examples.

### Exemplary Example 1

A multi-element metal solution is fed into a first Couette-Taylor reactor. The multi-element metal solution is an aqueous solution added with NiSO₄, CoSO₄, and MnSO₄ with a molar ratio of 8:1:1, and a total molarity of the multi-element metal substances (NiSO₄, CoSO₄, and MnSO₄) is 2M. A precipitating agent NaOH(aq) and a chelating agent NH₄OH(aq) are fed into the first Couette-Taylor reactor to perform a co-precipitation reaction to form a liquid solution containing nickel-cobalt-manganese ternary alloy hydroxide particles.

A reaction temperature of the first Couette-Taylor reactor is 60° C., a motor rotation speed is 600 rpm, an average residence time of the material is 500 min, a flow rate of the feed material (i.e., the multi-element metal solution) is 1.5 mL/min, a flow rate of the chelating agent NH₄OH(aq) is 0.5 mL/min, and a flow rate of the precipitating agent NaOH(aq) having a molarity of 4M is adjusted to control the pH value of the solution to be pH 11.

Then, the liquid solution containing the nickel-cobalt-manganese ternary alloy hydroxide particles outputted from the first Couette-Taylor reactor is fed into a second Couette-Taylor reactor. In addition, an aqueous coating material solution (i.e., zirconium sulfate solution with a molarity of 1M), another precipitating agent NaOH(aq), and another chelating agent NH₄OH (aq) are fed into the second Couette-Taylor reactor to form a transition metal coating material layer on a surface of each of the nickel-cobalt-manganese ternary alloy hydroxide particles to generate a solution containing a plurality of cathode active material precursors. Each of the cathode active material precursors has a core-shell structure.

A reaction temperature of the second Couette-Taylor reactor is 60° C., a motor rotation speed is 600 rpm, an average residence time of the material is 377 min, a flow rate of the feed material (i.e., the aqueous coating material solution) is 0.15 mL/min, a flow rate of the chelating agent NH₄OH(aq) is 0.5 mL/min, and a flow rate of the precipitating agent NaOH(aq) having a molarity of 4M is adjusted to control the pH value of the solution to be pH 11.

Finally, the liquid solution containing the cathode active material precursors is filtered, cleaned, and dried to separate the cathode active material precursors from the liquid solution.

The cathode active material precursors are then mixed and ball milled with the lithium source (lithium hydroxide), and then an oxygen gas is introduced into a high-temperature tubular furnace for calcining the cathode active material precursors, so as to obtain a nickel-rich cathode oxide substance.

Then, the nickel-rich cathode oxide substance is tested for electrochemical properties.

### Exemplary Example 2

A multi-element metal solution is fed into a first Couette-Taylor reactor. The multi-element metal solution is an aqueous solution added with NiSO₄, CoSO₄, and MnSO₄ with a molar ratio of 8:1:1, and a total molarity of the multi-element metal substances (NiSO₄, CoSO₄, and MnSO₄) is 2M. A precipitating agent NaOH(aq) and a chelating agent NH₄OH(aq) are fed into the first Couette-Taylor reactor to perform a co-precipitation reaction to form a liquid solution containing nickel-cobalt-manganese ternary alloy hydroxide particles.

A reaction temperature of the first Couette-Taylor reactor is 60° C., a motor rotation speed is 600 rpm, an average residence time of the material is 500 min, a flow rate of the feed material (i.e., the multi-element metal solution) is 1.5 mL/min, a flow rate of the chelating agent NH₄OH(aq) is 0.5 mL/min, and a flow rate of the precipitating agent NaOH(aq) having a molarity of 4M is adjusted to control the pH value of the solution to be pH 11.

Then, the liquid solution containing the nickel-cobalt-manganese ternary alloy hydroxide particles outputted from the first Couette-Taylor reactor is fed into a second Couette-Taylor reactor. In addition, an aqueous coating material solution (i.e., tungsten ion solution with a molarity of 0.1M), another precipitating agent NaOH(aq), and another chelating agent NH₄OH(aq) are fed into the second Couette-Taylor reactor to form a transition metal coating material layer on a surface of each of the nickel-cobalt-manganese ternary alloy hydroxide particles to generate a solution containing a plurality of cathode active material precursors. Each of the cathode active material precursors has a core-shell structure.

A reaction temperature of the second Couette-Taylor reactor is 60° C., a motor rotation speed is 600 rpm, an average residence time of the material is 377 min, a flow rate of the feed material (i.e., the aqueous coating material solution) is 0.15 mL/min, a flow rate of the chelating agent NH₄OH(aq) is 0.5 mL/min, and a flow rate of the precipitating agent NaOH(aq) having a molarity of 4M is adjusted to control the pH value of the solution to be pH 11.

Finally, the liquid solution containing the cathode active material precursors is filtered, cleaned, and dried to separate the cathode active material precursors from the liquid solution. The cathode active material precursors are then mixed and ball milled with the lithium source (lithium hydroxide), and then an oxygen gas is introduced into a high-temperature tubular furnace for calcining the cathode active material precursors, so as to obtain a nickel-rich cathode oxide substance. Then, the nickel-rich cathode oxide substance is tested for electrochemical properties.

### Exemplary Example 3

A multi-element metal solution is fed into a first Couette-Taylor reactor. The multi-element metal solution is an aqueous solution added with NiSO₄, CoSO₄, MnSO₄, and MgSO₄ with a molar ratio of 8:1:0.9:0.1, and a total molarity of the multi-element metal substances (NiSO₄, CoSO₄, MnSO₄, and MgSO₄) is 2M. A precipitating agent NaOH(aq) and a chelating agent NH₄OH(aq) are fed into the first Couette-Taylor reactor to perform a co-precipitation reaction to form a liquid solution containing nickel-cobalt-manganese-magnesium quaternary alloy hydroxide particles.

A reaction temperature of the first Couette-Taylor reactor is 60° C., a motor rotation speed is 600 rpm, an average residence time of the material is 500 min, a flow rate of the feed material (i.e., the multi-element metal solution) is 1.5 mL/min, a flow rate of the chelating agent NH₄OH(aq) is 0.5 mL/min, and a flow rate of the precipitating agent NaOH(aq) having a molarity of 4M is adjusted to control the pH value of the solution to be pH 11.2.

Then, the liquid solution containing the nickel-cobalt-manganese-magnesium quaternary alloy hydroxide particles outputted from the first Couette-Taylor reactor is fed into a second Couette-Taylor reactor. In addition, an aqueous coating material solution (i.e., aluminum ion solution with a molarity of 1M), another precipitating agent NaOH(aq), and another chelating agent NH₄OH(aq) are fed into the second Couette-Taylor reactor to form a transition metal coating material layer on a surface of each of the nickel-cobalt-manganese-magnesium quaternary alloy hydroxide particles to generate a solution containing a plurality of cathode active material precursors, and each of the cathode active material precursors has a core-shell structure.

A reaction temperature of the second Couette-Taylor reactor is 60° C., a motor rotation speed is 600 rpm, an average residence time of the material is 384 min, a flow rate of the feed material (i.e., the aqueous coating material solution) is 0.15 mL/min, a flow rate of the chelating agent NH₄OH(aq) is 0.5 mL/min, and a flow rate of the precipitating agent NaOH(aq) having a molarity of 4M is adjusted to control the pH value of the solution to be pH 11.2.

Finally, the liquid solution containing the cathode active material precursors is filtered, cleaned, and dried to separate the cathode active material precursors from the liquid solution.

The cathode active material precursors are then mixed and ball milled with the lithium source (lithium hydroxide), and then an oxygen gas is introduced into a high-temperature tubular furnace for calcining the cathode active material precursors, so as to obtain a nickel-rich cathode oxide substance.

Then, the nickel-rich cathode oxide substance is tested for electrochemical properties.

### Comparative Example 1

A multi-element metal solution is fed into a first Couette-Taylor reactor. The multi-element metal solution is an aqueous solution added with NiSO₄, CoSO₄, and MnSO₄ with a molar ratio of 8:1:1, and a total molarity of the multi-element metal substances (NiSO₄, CoSO₄, and MnSO₄) is 2M. A precipitating agent NaOH(aq) and a chelating agent NH₄OH(aq) are fed into the first Couette-Taylor reactor to perform a co-precipitation reaction to form a liquid solution containing nickel-cobalt-manganese ternary alloy hydroxide particles.

A reaction temperature of the first Couette-Taylor reactor is 60° C., a motor rotation speed is 600 rpm, an average residence time of the material is 500 min, a flow rate of the feed material (i.e., the multi-element metal solution) is 1.5 mL/min, a flow rate of the chelating agent NH₄OH(aq) is 0.5 mL/min, and a flow rate of the precipitating agent NaOH(aq) having a molarity of 4M is adjusted to control the pH value of the solution to be pH 11.

Finally, the liquid solution containing the nickel-cobalt-manganese ternary alloy hydroxide particles is filtered, cleaned, and dried to separate the nickel-cobalt-manganese ternary alloy hydroxide particles from the liquid solution. The the nickel-cobalt-manganese ternary alloy hydroxide particles are then mixed and ball milled with the lithium source (lithium hydroxide), and then an oxygen gas is introduced into a high-temperature tubular furnace for calcining the nickel-cobalt-manganese ternary alloy hydroxide particles, so as to obtain a cathode oxide substance. Then, the cathode oxide substance is tested for electrochemical properties.

The main difference between Comparative Example 1 and Exemplary Examples 1 to 3 is that Comparative Example 1 only uses a single Couette-Taylor reactor to prepare core particles, and no functional coating layer is formed on the core particles.

The preparation of the cathode oxide substance (i.e., the cathode material of the lithium battery) in the above Exemplary and Comparative Examples is described in more detail as follows.

The preparation of the cathode oxide substance is to prepare the precursor and the lithium salt (i.e., LiOH·H₂O, 98%, Sigma-Aldrich) using a solid-phase reaction method (i.e. planetary ball milling) into a chemical composition of LiNi_{0.8}Co_{0.1}Mn_{0.1}X_{Z}O₂ oxide cathode material (abbreviated as NCM811, and X is the surface metal). The molar ratio of the precursor to the lithium salt is 1:1.05. Then, the above mixed materials are calcined in a pure oxygen (O₂) atmosphere at 830° C. for 12 hours.

The electrical tests of Exemplary Examples 1 to 3 and Comparative Example 1 are conducted using CR2032 Lithium Button Cell Batteries to assemble the positive electrode and the lithium metal negative electrode and perform electrical property testing.

First, a positive electrode formula is made into electrode slurry, which includes cathode active material, Super P conductive additive, and PVDF adhesive, and undergoes processing steps such as stirring, coating, drying, rolling, and cutting.

Then, the prepared positive electrode sheet is assembled into a CR2032 half-cell, and then the gram capacitance of the synthetic material is detected and analyzed, including electrochemical performance indicators (KPI), such as the discharge capacity, coulombic efficiency (CE %), and specific capacity retention (CR %).

The electrical test results of Exemplary Examples 1 to 3 and Comparative Example 1 are as shown in Table 1 below.

TABLE 1

| | Exemplary | Exemplary | Exemplary | Comparative |
|---|---|---|---|---|
| | Example 1 | Example 2 | Example 3 | Example 1 |
| core particle | 6.45 | 6.62 | 6.80 | 6.21 |
| size | | | | |
| (micrometers) | | | | |
| 0.1 C first | 186.38 | 187.96 | 186.4 | 190.4 |
| discharge | | | | |
| capacity | | | | |
| (mAH/g) | | | | |
| first charge and | 88.6 | 87.0 | 89.1 | 86.8 |
| discharge | | | | |
| efficiency (%) | | | | |
| 1 C 100 | 88.56 | 81.95 | 91.56 | 75.2 |
| charge- | | | | |
| discharge cycle | | | | |
| maintenance | | | | |
| rate (%) | | | | |
| surface cracks | No obvious | No obvious | No obvious | Obvious |
| observed after | cracks | cracks | cracks | cracks |
| charging and | | | | |
| discharge 500 | | | | |
| times | | | | |

The experimental results in Table 1 shows that the cathode materials of Exemplary Examples 1 to 3 have better performance in terms of cycle maintenance rate of 100 charge and discharge cycles. The cycle maintenance rate is 81.95% to 91.56%. Furthermore, the cathode materials of Exemplary Examples 1 to 3 are tested for 500 times of charging and discharging, and there are no obvious cracks on the surface of the cathode materials.

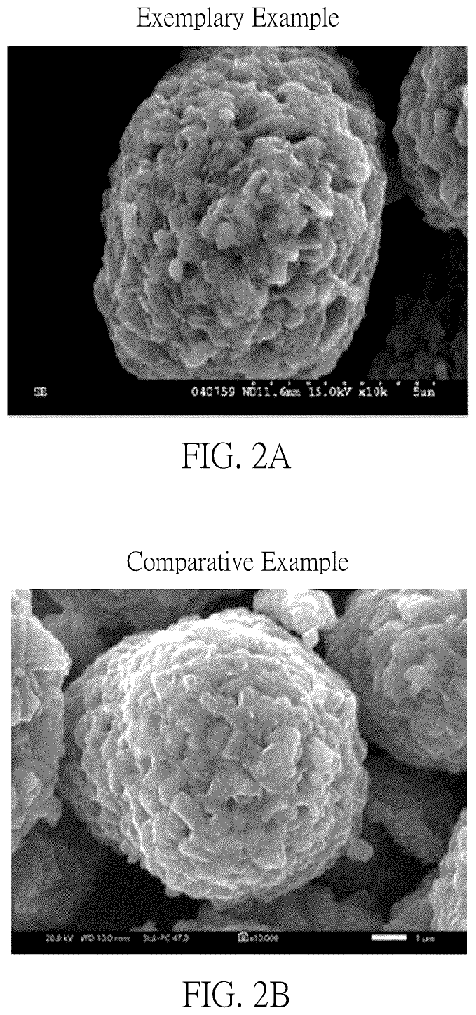

In terms of scanning electron microscopy (SEM) analysis, FIG. 2A is an SEM photograph of a cathode active material having a core-shell structure of Exemplary Example 3 of the present disclosure. FIG. 2B is an SEM photograph of a cathode active material having only a core particle of Comparative Example 1.

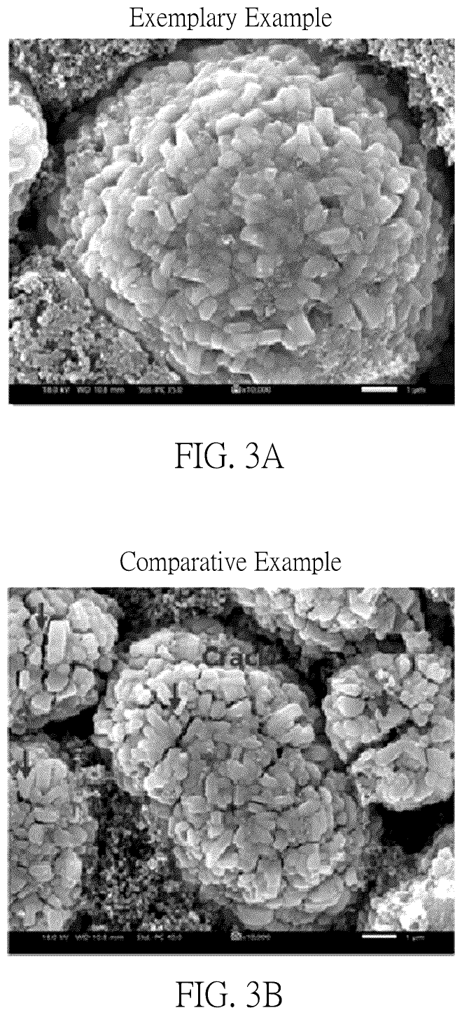

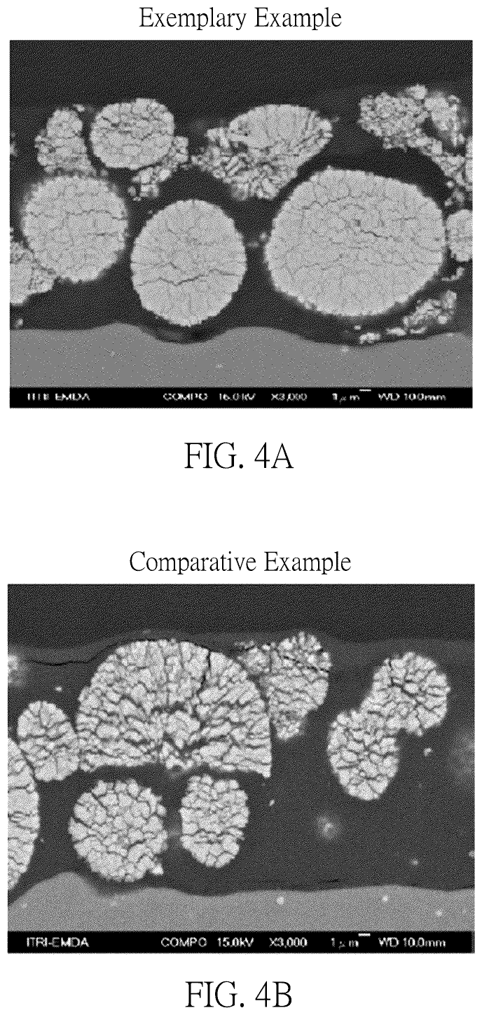

FIG. 3A is an SEM photograph of the cathode active material having the core-shell structure of Exemplary Example 3 of the present disclosure after 500 charge and discharge cycle tests. FIG. 3B is an SEM photograph of the cathode active material having only the core particle of Comparative Example 1 after 500 charge and discharge cycle tests. FIG. 4A is an SEM photograph showing a cross-sectional view of the cathode active material of FIG. 3A. FIG. 4B is an SEM photograph showing a cross-sectional view of the cathode active material of FIG. 3B.

After the cathode material having the core-shell structure shown in FIG. 3A and FIG. 4A are charged and discharged for 500 times, no obvious cracks are observed on the surfaces of the materials.

After the cathode material with only the core particles in FIG. 3B and FIG. 4B are charged and discharged for 500 times, obvious cracks are observed on the surfaces of the materials.

### Beneficial Effects of the Embodiments

In conclusion, in the method of preparing the cathode active material precursors using the Couette-Taylor reactors provided by the present disclosure, by virtue of “implementing a first Couette-Taylor reaction step that includes: feeding a first reaction liquid into a first Couette-Taylor reactor; performing a co-precipitation reaction on the first reaction liquid to continuously form and output a first product liquid stream containing a plurality of core particles; in which the first reaction liquid is a multi-element metal solution,” and “implementing a second Couette-Taylor reaction step that includes: feeding the first product liquid stream into a second Couette-Taylor reactor that is connected in series after the first Couette-Taylor reactor; feeding a second reaction liquid into the second Couette-Taylor reactor to react with the core particles, so that a functional coating layer formed by the second reaction liquid is covered on an outer surface of each of the core particles, and a second product liquid stream containing the cathode active material precursors each having a core-shell structure is then formed; in which the second reaction liquid is a coating material aqueous solution, and the coating material aqueous solution is a transition metal aqueous solution,” and “implementing a purification step that includes: purifying the second product liquid stream to separate the cathode active material precursors from the second product stream,” conventional continuous stirred reactors can be replaced, and the purpose of continuous production can be achieved.

The first Couette-Taylor reactor is used to form core particles (i.e., core portions) with uniform elements distribution and a dense structure through a co-precipitation method. Further, the second Couette-Taylor reactor is used to surface coat and modify the core particles to form cathode active material precursors each having a core-shell structure. The method of the present disclosure can achieve continuous production of cathode material precursors each having the core-shell structure, which effectively enhances stability and endurance of lithium batteries, while also ensuring safety of the materials.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method of preparing cathode active material precursors using Couette-Taylor reactors, comprising:
implementing a first Couette-Taylor reaction step including:
feeding a first reaction liquid into a first Couette-Taylor reactor;
performing a co-precipitation reaction on the first reaction liquid to continuously form and output a first product liquid stream containing a plurality of core particles;
wherein the first reaction liquid is a multi-element metal solution;
implementing a second Couette-Taylor reaction step including:
feeding the first product liquid stream into a second Couette-Taylor reactor that is connected in series after the first Couette-Taylor reactor;
feeding a second reaction liquid into the second Couette-Taylor reactor to react with the core particles, so that a functional coating layer formed by the second reaction liquid is covered on an outer surface of each of the core particles, and a second product liquid stream containing the cathode active material precursors each having a core-shell structure is then formed; wherein the second reaction liquid is a coating material aqueous solution, and the coating material aqueous solution is a transition metal aqueous solution; and
implementing a purification step including: purifying the second product liquid stream to separate the cathode active material precursors from the second product stream.

2. The method according to claim 1, wherein the multi-element metal solution contains at least three or more of a nickel (Ni) compound, a cobalt (Co) compound, a manganese (Mn) compound, a magnesium (Mg) compound, and an aluminum (Al) compound; wherein each of the core particles is at least one of a ternary alloy hydroxide core particle and a quaternary alloy hydroxide core particle.

3. The method according to claim 1, wherein the transition metal aqueous solution is at least one of a zirconium ion solution, a tungsten ion solution, an aluminum ion solution, a zinc ion solution, a titanium ion solution, a molybdenum ion solution, and a tin ion solution.

4. The method according to claim 1, wherein a flow rate of the first reaction liquid fed into the first Couette-Taylor reactor is defined as a first liquid flow rate, and a flow rate of the second reaction liquid fed into the second Couette-Taylor reactor is defined as a second liquid flow rate; wherein the second liquid flow rate is 3% to 20% of the first liquid flow rate.

5. The method according to claim 1, wherein a first liquid flow rate of the first reaction liquid fed into the first Couette-Taylor reactor is between 0.5 mL/min and 3 mL/min, a second liquid flow rate of the second reaction liquid fed into the second Couette-Taylor reactor is between 0.05 mL/min and 0.30 mL/min, and the second liquid flow rate is 3% to 20% of the first liquid flow rate.

6. The method according to claim 1, wherein a first reaction temperature of the first Couette-Taylor reactor is between 45° C. and 70° C., and a first rotation speed of a first rotation motor in the first Couette-Taylor reactor is between 500 rpm and 900 rpm.

7. The method according to claim 6, wherein a second reaction temperature of the second Couette-Taylor reactor is between 45° C. and 70° C., and a second rotation speed of a second rotation motor in the second Couette-Taylor reactor is between 400 rpm and 800 rpm.

8. The method according to claim 1, wherein the first Couette-Taylor reaction step further includes: respectively feeding a first chelating agent and a first precipitating agent into the first Couette-Taylor reactor to mix with the first reaction liquid, so as to form a first reaction mixture; wherein a first residence time of the first reaction mixture in the first Couette-Taylor reactor is between 300 minutes and 600 minutes.

9. The method according to claim 8, wherein the second Couette-Taylor reaction step further includes: respectively feeding a second chelating agent and a second precipitating agent into the second Couette-Taylor reactor to mix with the second reaction liquid and the first product liquid stream, so as to form a second reaction mixture; wherein a second residence time of the second reaction mixture in the second Couette-Taylor reactor is between 150 minutes and 500 minutes, and the second residence time is 50% to 85% of the first residence time.

10. The method according to claim 1, wherein, in each of the cathode active material precursors having the core-shell structure, a core size of the core particle is between 4 micrometers and 12 micrometers, and a thickness of the functional coating layer is 1% and 20% of the core size of the core particle.
